(19) United States
(12) Patent Application Publication
(10) Pub. No.: US 2006/0282531 A1
(43) Pub. Date: Dec. 14, 2006

(54) Network interface apparatus for controlling image data forwarding according to performance function of each address and method thereof

(75) Inventor: Jin-tack Lee, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/439,279

(22) Filed: May 24, 2006

(30) Foreign Application Priority Data
May 24, 2005 (KR) 2005-43518

(51) Int. Cl. H04L 12/66; G06F 15/173

(52) U.S. Cl. 709/224; 370/352

(57) ABSTRACT

A method that includes controlling image data forwarding in a network interface apparatus according to a performance function of each address. Also, a network interface apparatus allocated with different addresses for the connected networks includes a memory storing an address-performance function indicating a corresponding function that the image forming apparatus can perform for each address of the network interface apparatus, and a controlling part determining an address of the network interface apparatus used in a network connected to an external terminal device, the controlling part determining whether the image forming apparatus can perform a function based on the determined address and the address-performance function, and controlling whether to forward image data between the external terminal device and the image forming apparatus based on the determined result. Accordingly, a single input operation can control performance functions of the image forming apparatus to the terminal devices connected to a network.

### CROSS-REFERENCE TO RELATED APPLICATIONS

This application claims the benefit of Korean Application No. 2005-43518, filed May 24, 2005, in the Korean Intellectual Property Office, the disclosure of which is incorporated herein by reference.

### BACKGROUND OF THE INVENTION

1. Field of the Invention

Aspects of the invention relate to a network interface apparatus and a method of controlling image data forwarding. More particularly, the invention relates to a network interface apparatus to control image data forwarding according to a performance function of each address and a method thereof.

2. Description of the Related Art

An image forming apparatus typically generates, prints, receives and transmits image data, and examples of such image forming apparatus integrated with these functions include a printer, a scanner, a copying machine, a facsimile and a multi function peripheral.

Where a network interface card is mounted on the image forming apparatus, the image forming apparatus forwards and receives image data to/from terminal devices connected to networks. As a result, the image forming apparatus can perform functions, such as forwarding image data generated by itself to a terminal device, printing image data received from a terminal device, or the like. However, the above functions can be limited for a particular terminal device so that ‘IP filtering’ has been utilized. Internet protocol (IP) filtering prevents the image forming apparatus from being connected to the particular terminal device so that image data between them can not be forwarded and received. To set up IP filtering, an IP address for the particular terminal device has to be input by a user.

Referring to FIG. 1, FIG. 1 shows a user interface used to input an IP address for a particular terminal device upon setting up IP filtering. As shown in the user interface of FIG. 1, a user has to input IP addresses for the particular terminal devices respectively, which can be inconvenient, particularly where there are many terminal devices to block.

### SUMMARY OF THE INVENTION

An aspect of the invention is to promote addressing the above needs and to provide various advantages in this regard. Accordingly, an aspect, among other aspects, of the invention is to provide a network interface apparatus to control image data forwarding between an external terminal device and the image forming apparatus according to performance functions of addresses respectively allocated to connected networks and a method thereof.

In order to achieve the above-described aspects and/or other aspects of the invention, there is provided a network interface apparatus of an image forming apparatus, connected to one or more networks for communication, and allocated with different addresses for the connected networks respectively, including: a memory to store an address-performance function indicating a function that the image forming apparatus can perform for each address of the network interface apparatus, and a controlling part to determine an address of the network interface apparatus used in a network connected to an external terminal device, to determine whether the image forming apparatus can perform a function based on the determined address and the address-performance function stored in the memory, and to control whether to forward image data between the external terminal device and the image forming apparatus based on the determination.

The controlling part can, based upon the determination, execute control to forward the image data between the external terminal device and the image forming apparatus, in response to the image forming apparatus determining to perform the corresponding function, and the controlling part can, based upon the determination, execute control not to forward the image data between the external terminal device and the image forming apparatus, in response to the image forming apparatus determining not to perform the corresponding function. Also, the controlling part can discard the image data and transmit a message that performance is not possible to at least one of the external terminal device and the image forming apparatus, in response to the image forming apparatus determining not to perform the corresponding function.

The network interface apparatus further includes: a network interface to communicate with the external terminal device through the network connected to the external terminal device; and an image forming module interface to communicate with an image forming module of the image forming apparatus. The controlling part can control whether to transmit the image data between the network interface and the image forming module interface based on the determination of whether the image forming apparatus can perform a corresponding function based on the determined address and the address-performance function.

The controlling part determines whether to perform image data-reception of the image forming apparatus, based on the address of the network interface apparatus used in the network connected to the external terminal device and the address-performance function, in response to the network interface receiving a request for image data-reception from the external terminal device. In response to the controlling part determining to perform image data-reception, the controlling part executes control to forward the image data included in the image data-reception request received in the network interface to the image forming module through the image forming module interface. In response to the controlling part determining not to perform image data-reception, the controlling part discards the image data-reception request received in the network interface. The image data-reception can include at least one function of printing print data received from the external terminal apparatus and printing facsimile data received from the external terminal apparatus.

The controlling part determines whether to perform image data-forwarding of the image forming apparatus based on the address of the network interface apparatus used in the network connected to the external terminal device receiving the image data included in the image data-forwarding request and the address-performance function, in response to the image forming module interface receiving an image data-forwarding request from the image forming module. In response to the controlling part determining to perform image data-forwarding, the controlling part executes control to transmit the image data included in the image data-forwarding request received in the image forming module interface to the external terminal device through the network interface. In response to the controlling part determining not to perform image data-forwarding, the controlling part discards the image data-forwarding request received in the image forming module interface. Also, the image data-forwarding can include at least one function of transmitting scan data generated by the image forming module to the external terminal device and transmitting facsimile data generated by the image forming module to the external terminal device.

According to another aspect of the invention, there is provided a method of controlling image data forwarding by a network interface apparatus of an image forming apparatus, connected to one or more networks for communication, and allocated with different addresses for the connected networks respectively, including: determining an address of the network interface apparatus used in a network connected to an external terminal device, determining whether the image forming apparatus can perform a function based on the determined address and the address-performance function indicating a performance function of the image forming apparatus for each address of the network interface apparatus, and controlling whether to forward image data between the external terminal device and the image forming apparatus based on the determination.

The controlling operation can include executing control to forward the image data between the external terminal device and the image forming apparatus, in response to the image forming apparatus determining to perform the corresponding function, and executing control not to forward the image data between the external terminal device and the image forming apparatus, in response to the image forming apparatus determining not to perform the corresponding function. The controlling operation can further include discarding the image data, in response to the image forming apparatus determining not to perform the corresponding function, and transmitting a message that performance is not possible to at least one of the external terminal device and the image forming apparatus.

Also, the controlling operation controls whether to forward the image data between the network interface communicating with the external terminal device through a network connected to the external terminal device and the image forming module interface communicating with an image forming module of the image forming apparatus based on the determination of the performance function of the image forming apparatus.

Further, the controlling operation can include determining the network connected to the external terminal device, in response to the network interface receiving a request for image data-reception from the external terminal device, determining whether to perform image data-reception of the image forming apparatus based on the address of the network interface apparatus used in the determined network and the address-performance function, controlling to transmit the image data included in the image data-reception request received in the network interface to the image forming module through the image forming module interface, in response to the controlling part determining to perform image data-reception, and discarding the image data-reception request received in the network interface, in response to the controlling part determining not to perform image data-reception. The image data-reception can include at least one function of printing print data received from the external terminal apparatus and printing facsimile data received from the external terminal apparatus.

According to a further aspect of the invention, the controlling operation can include determining the network connected to the external terminal device receiving the image data included in the image data-forwarding request, in response to the image forming module interface receiving a image data-forwarding request from the image forming module, determining whether to perform image data-forwarding of the image forming apparatus based on the address of the network interface apparatus used in the determined network and the address-performance function, controlling to forward the image data included in the image data-forwarding request received in the image forming module interface to the external terminal device through the network interface, in response to the controlling part determining to perform image data-forwarding, and discarding the image data-forwarding request received in the image forming module interface, in response to the controlling part determining not to perform image data-forwarding. The image data-forwarding can include at least one function of transmitting scan data generated by the image forming module to the external terminal device and transmitting facsimile data generated by the image forming module to the external terminal device.

An image forming apparatus according to an embodiment of the present invention includes an image forming module generating and printing the image data, and a network interface determining whether to forward the image data between the external terminal device and the image forming module based on whether to perform the function determined by using an address-performance function indicating functions to perform for each address used in a plurality of connected networks and an address used in the network connected to the external terminal device.

Additional aspects and/or advantages of the invention are set forth in or are evident from the description, or can be learned by practice of the invention.

The network interface determines, by the address-performance function, functions to perform by the image forming apparatus for each corresponding address of the network interface in a plurality of connected networks.

Further, a memory to store an address-performance function indicating a corresponding function that the image forming apparatus can perform for each address of the network interface; and a controlling part to determine an address of the network interface in a network connected to an external terminal device, to determine whether the image forming apparatus can perform the corresponding function based on the determined address and the address-performance function stored in the memory, and to control whether to forward image data between the external terminal device and the image forming apparatus based on the determination.

The controlling part executes control to forward the image data between the external terminal device and the image forming apparatus, in response to the determination to perform the corresponding function, and the controlling part executes control not to forward the image data between the external terminal device and the image forming apparatus, in response to the determination not to perform the corresponding function.

The controlling part discards the image data and transmits a message that performance of the corresponding function is not possible to one of the external terminal device and the image forming apparatus, in response to the determination not to perform the corresponding function.

The controlling part determines whether to perform image data-reception by the image forming apparatus based on the address of the network interface in the network connected to the external terminal device and the address-performance function, in response to the network interface receiving a request for image data-reception from the external terminal device, and in response to the determination of the controlling part to perform image data-reception, the controlling part executes control to forward the image data included in the image data-reception request received in the network interface to the image forming module through an image forming module interface, and in response to the determination of the controlling part not to perform image data-reception, the controlling part discards the image data-reception request received in the network interface.

The image data-reception includes at least one function of to print data, as print data, received from the external terminal device and to print facsimile data received from the external terminal device.

The controlling part determines whether to perform image data-forwarding by the image forming apparatus based on the address of the network interface in the network connected to the external terminal device to receive the image data included in the image data-forwarding request and the address-performance function, in response to the image forming module interface receiving an image data-forwarding request from the image forming module, and in response to the determination of the controlling part to perform image data-forwarding, the controlling part executes control to transmit the image data included in the image data-forwarding request received in the image forming module interface to the external terminal device through the network interface, and in response to the determination of the controlling part not to perform image data-forwarding, the controlling part discards the image data-forwarding request received in the image forming module interface.

The image data-forwarding includes at least one function of to transmit scan data generated by the image forming module to the external terminal device and to transmit facsimile data generated by the image forming module to the external terminal device.

The controlling part determines whether to perform image data-forwarding by the image forming apparatus based on the address of the network interface in the network connected to the external terminal device to receive the image data included in the image data-forwarding request and the address-performance function, in response to an image forming module interface receiving an image data-forwarding request from the image forming module, and in response to the determination of the controlling part to perform image data-forwarding, the controlling part executes control to transmit the image data included in the image data-forwarding request received in the image forming module interface to the external terminal device through the network interface, and in response to the determination of the controlling part not to perform image data-forwarding, the controlling part discards the image data-forwarding request received in the image forming module interface.

The image data-forwarding includes at least one function of to transmit scan data generated by the image forming module to the external terminal device and to transmit facsimile data generated by the image forming module to the external terminal device.

Further, a network interface to communicate with the external terminal device through the network connected to the external terminal device.

The controlling part determines whether to perform image data-reception by the image forming apparatus based on the address of the network interface apparatus in the network connected to the external terminal device and the address-performance function, in response to the network interface receiving a request for image data-reception from the external terminal device, and in response to the determination of the controlling part to perform image data-reception, the controlling part executes control to forward the image data included in the image data-reception request received in the network interface, and in response to the determination of the controlling part not to perform image data-reception, the controlling part discards the image data-reception request received in the network interface.

The image data-reception includes at least one function of to print data, as print data, received from the external terminal device and to print facsimile data received from the external terminal device.

The controlling part determines whether to perform image data-forwarding by the image forming apparatus based on the address of the network interface apparatus in the network connected to the external terminal device to receive the image data included in the image data-forwarding request and the address-performance function, in response to reception of an image data-forwarding request, and in response to the determination of the controlling part to perform image data-forwarding, the controlling part executes control to transmit the image data included in the image data-forwarding request to the external terminal device through the network interface, and in response to the determination of the controlling part not to perform image data-forwarding, the controlling part discards the image data-forwarding request.

The image data-forwarding includes at least one function of to transmit scan data generated to the external terminal device and to transmit facsimile data generated to the external terminal device.

The controlling part determines whether to perform image data-forwarding by the image forming apparatus based on the address of the network interface apparatus in the network connected to the external terminal device to receive the image data included in the image data-forwarding request and the address-performance function, in response to reception of an image data-forwarding request, and in response to the determination of the controlling part to perform image data-forwarding, the controlling part executes control to transmit the image data included in the image data-forwarding request to the external terminal device through the network interface, and in response to the determination of the controlling part not to perform image data-forwarding, the controlling part discards the image data-forwarding request.

The image data-forwarding includes at least one function of to transmit scan data generated to the external terminal device and to transmit facsimile data generated to the external terminal device.

The controlling part determines whether to perform image data-forwarding by the image forming apparatus based on the address of the network interface apparatus in the network connected to the external terminal device to receive the image data included in the image data-forwarding request and the address-performance function, in response to the image forming module interface receiving an image data-forwarding request from the image forming module, and in response to the determination of the controlling part to perform image data-forwarding, the controlling part executes control to transmit the image data included in the image data-forwarding request received in the image forming module interface to the external terminal device through the network interface, and in response to the determination of the controlling part not to perform image data-forwarding, the controlling part discards the image data-forwarding request received in the image forming module interface.

The image data-forwarding includes at least one function of to transmit scan data generated by the image forming module to the external terminal device and to transmit facsimile data generated by the image forming module to the external terminal device.

The controlling operation further includes: determining the network connected to the external terminal device to receive the image data included in an image data-forwarding request, in response to the image forming module interface receiving the image data-forwarding request from the image forming module; determining whether to perform image data-forwarding by the image forming apparatus based on the address of the network interface apparatus in the determined network and the address-performance function; executing control to forward the image data included in the image data-forwarding request received in the image forming module interface to the external terminal device through the network interface apparatus, in response to the determination to perform image data-forwarding; and discarding the image data-forwarding request received in the image forming module interface, in response to the determination not to perform image data-forwarding.

The image data-forwarding includes at least one function of to transmit scan data generated by the image forming module to the external terminal device and to transmit facsimile data generated by the image forming module to the external terminal device.

In order to achieve the above-described aspects and/or other aspects of the invention, there is provided a method of controlling image data forwarding by a network interface apparatus of an image forming apparatus, includes: determining the corresponding address of the network interface apparatus in a network connected to an external terminal device; determining whether the image forming apparatus performs a corresponding function based on the determined address and the address-performance function indicating whether performance of the corresponding function is possible by the image forming apparatus; and controlling whether to forward image data between the external terminal device and the image forming apparatus based on the result of the determination as to whether performance of the corresponding function by the image forming apparatus is possible.

The controlling operation further includes: executing control to forward the image data between the external terminal device and the image forming apparatus, in response to the determination to perform the corresponding function; and executing control not to forward the image data between the external terminal device and the image forming apparatus, in response to the determination not to perform the corresponding function.

The controlling operation further includes: discarding the image data, in response to the determination not to perform the corresponding function.

The controlling operation further includes: transmitting a message that performance of the corresponding function is not possible to one of the external terminal device and the image forming apparatus.

The controlling operation further includes: transmitting a message that performance of the corresponding function is not possible to one of the external terminal device and the image forming apparatus.

The controlling operation further includes: determining the network connected to the external terminal device, in response to receiving an image data-reception request from the external terminal device; determining whether to perform image data-reception by the image forming apparatus based on the address of the network interface apparatus in the determined network and the address-performance function; executing control to transmit the image data included in the image data-reception request received, in response to the determination to perform image data-reception; and discarding the image data-reception request received, in response to the determination not to perform image data-reception.

The image data-reception includes at least one function of to print data, as print data, received from the external terminal device and to print facsimile data received from the external terminal device.

The controlling operation further includes: determining the network connected to the external terminal device requesting to receive the image data included in an image data-forwarding request, in response to receiving an image data-forwarding request by the network interface apparatus; determining whether to perform image data-forwarding by the image forming apparatus based on the address of the network interface apparatus in the determined network and the address-performance function; executing control to forward the image data included in the image data-forwarding request received to the external terminal device through the network interface apparatus, in response to the determination to perform image data-forwarding; and discarding the image data-forwarding request received from the external terminal device, in response to the determination not to perform image data-forwarding.

The image data-forwarding includes at least one function of to transmit scan data generated by the image forming apparatus to the external terminal device and to transmit facsimile data generated by the image forming apparatus to the external terminal device.

The controlling operation further includes: determining the network connected to the external terminal device requesting to receive the image data included in an image data-forwarding request, in response to receiving an image data-forwarding request by the network interface apparatus; determining whether to perform image data-forwarding by the image forming apparatus based on the address of the network interface apparatus in the determined network and the address-performance function; executing control to forward the image data included in the image data-forwarding request received to the external terminal device through the network interface apparatus, in response to the determination to perform image data-forwarding; and discarding the image data-forwarding request received from the external terminal device, in response to the determination not to perform image data-forwarding.

The image data-forwarding includes at least one function of to transmit scan data generated by the image forming apparatus to the external terminal device and to transmit facsimile data generated by the image forming apparatus to the external terminal device.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view showing a user interface to input an IP address for a terminal device to block using conventional IP filtering;

FIG. 2 is a block diagram showing a network system according to an aspect of the invention;

FIG. 3 is a detailed block diagram showing a multi function peripheral of FIG. 2 according to an aspect of the invention;

FIG. 4A is a view showing an example of a user interface to set up performance functions for IP addresses according to an aspect of the invention;

FIG. 4B is a view showing ‘an IP address-performance function table’, where performance functions are set up as shown in FIG. 4A according to an aspect of the invention;

FIG. 5 is a flow chart describing a method of controlling image data forwarding according to a performance function of each IP address according to an embodiment of the invention;

FIG. 6A is a view showing another example of a user interface to set up performance functions for IP addresses according to an aspect of the invention; and

FIG. 6B is a view showing ‘an IP address-performance function table’, where performance functions are set up as shown in FIG. 6A according to an aspect of the invention.

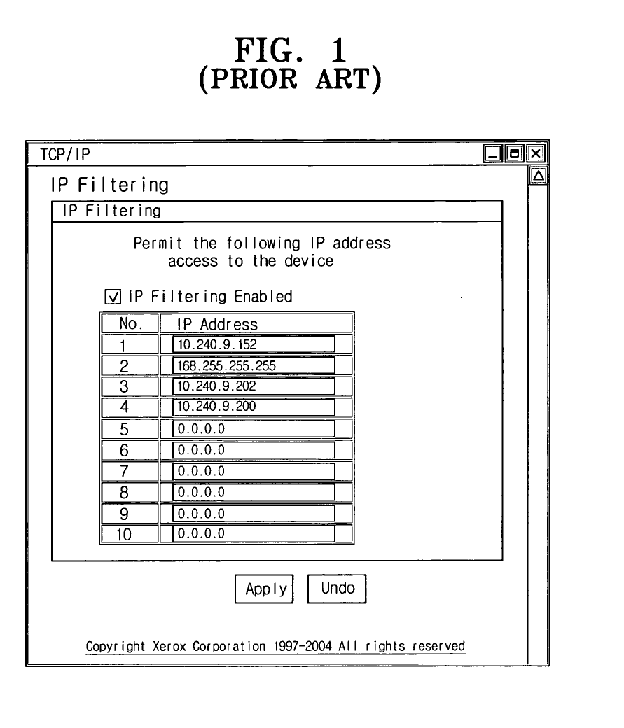

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain the invention by referring to the figures.

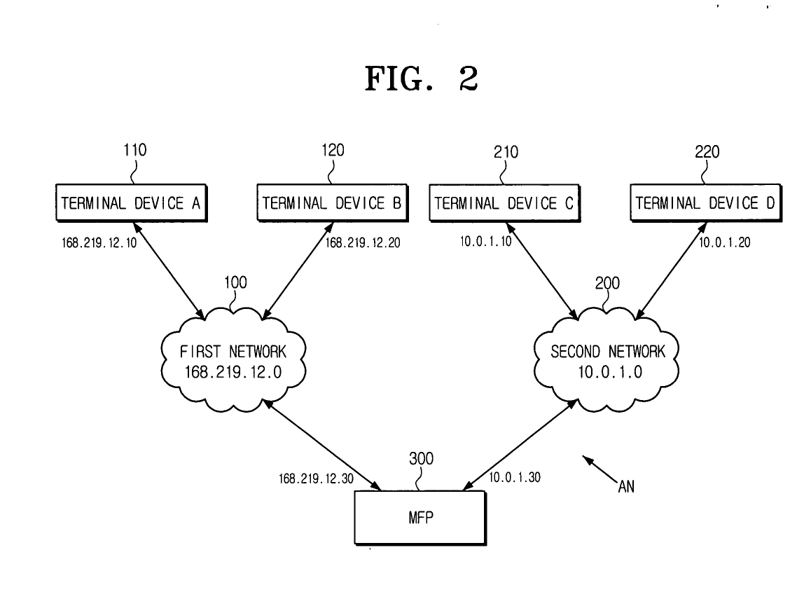

FIG. 2 is a block diagram showing a network system AN according to as aspect of invention and to which the invention can be applied. In this regard, FIG. 2 shows networks constructing the network system AN, devices connected to the networks and IP addresses for the networks and devices. The network system of FIG. 2 has a first network 100 whose IP address is ‘168.219.12.0’ and a second network 200 whose IP address is ‘10.0.1.0’, for example. The first network 100 is connected to a terminal device A 110 whose IP address is ‘168.219.12.10 and a terminal device B 120 whose IP address is ‘168.219.12.20, for example. Additionally, the second network 200 is connected to a terminal device C 210 whose IP address is ‘10.0.1.10’ and a terminal device D 220 whose IP address is ‘10.0.1.20’, for example.

Also, a multi function peripheral (MFP) 300 is connected to both the first network 100 and the second network 200 so that the MFP 300 can communicate with the terminal device A 110 and terminal device B 120 through the first network 100, and communicate with the terminal device C 210 and terminal device D 220 through the second network 200. Further, as connected to the two networks, the MFP 300 allocates two different IP addresses for the two networks. Under the two different IP addresses, ‘168.219.12.30’ is for the first network 100 and ‘10.0.1.30’ is for the second network 200, for example. The MFP 300 is an image forming apparatus which prints or forwards image data generated by itself to the outside of the MFP 300, and prints the image data received from the outside of the MFP 300. As the MFP 300 can communicate with all of the terminal devices 110, 120, 210, 220 of FIG. 2 through the networks 100, 200, the MFP 300 can forward image data to the terminal devices 110, 120, 210, 220 or receive image data from the terminal devices 110, 120, 210, 220.

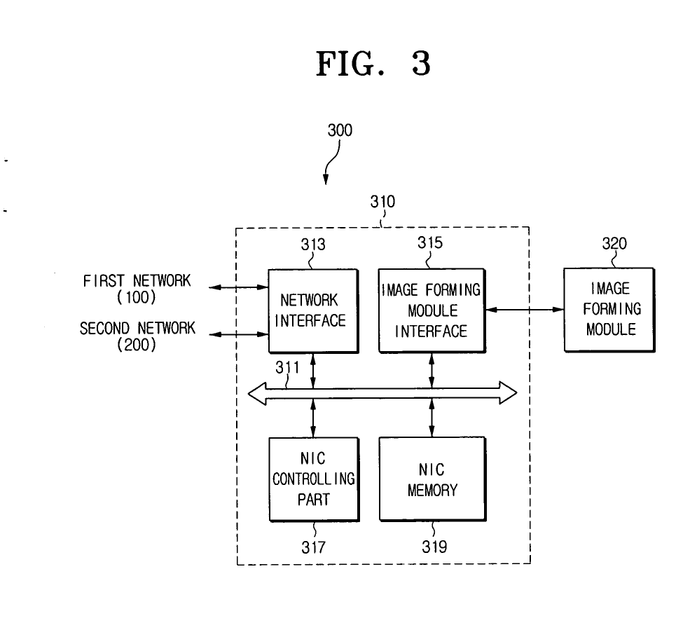

FIG. 3 is a detailed block diagram showing the MFP 300 according to an aspect of the invention. As shown in FIG. 3, the image forming apparatus MFP 300 includes a network interface card (NIC) 310 and an image forming module 320. The image forming module 320 generates or prints image data. The image data which the image forming module 320 prints include image data generated by itself through scanning and image data which the NIC 310 receives from the terminal devices 110, 120, 210, 220. In addition, the image data generated by the image forming module 320 can be forwarded to the terminal devices 110, 120, 210, 220 by the NIC 310.

In the MFP 300, the NIC 310 is a network interface apparatus which can be mounted on the MFP 300 and is connected to the networks 100, 200 for communication with the networks 100, 200. As described above, two addresses, corresponding to the networks 100, 200, are allocated to the MFP 300, and the two addresses are allocated to the NIC 310. The NIC 310 includes a network interface 313, an image forming module interface 315, an NIC controlling part 317 and an NIC memory 319, which are connected to each other through a bus 311. The network interface 313 communicates with the terminal devices 110, 120, 210, and 220 through the networks 100, 200. Specifically, the network interface 313 can forward and receive image data to/from the terminal device A 110 and the terminal device B 120 through the first network 100, and can forward and receive image data to/from the terminal device C 210 and terminal device D 220 through the second network 200.

In the NIC 310, the image forming module interface 315 communicates with the image forming module 320. Specifically, the image forming module interface 315 can forward and receive image data to/from the image forming module 320. The NIC memory 319 stores an ‘IP address-performance function table’, to be further described. The NIC controlling part 317 controls whether to forward image data between the network interface 313 and the image forming module interface 315 according to the ‘IP address-performance function table’ stored in the NIC memory 319. The NIC controlling part 317, as a controller, for example, can be a microprocessor, processor or an application specific integrated circuit (ASIC), having the requisite software or programming, and associated with a memory, such as the NIC memory 319, to implement the requisite functions of the NIC 310, and/or other functions, in the image forming apparatus MFP 300.

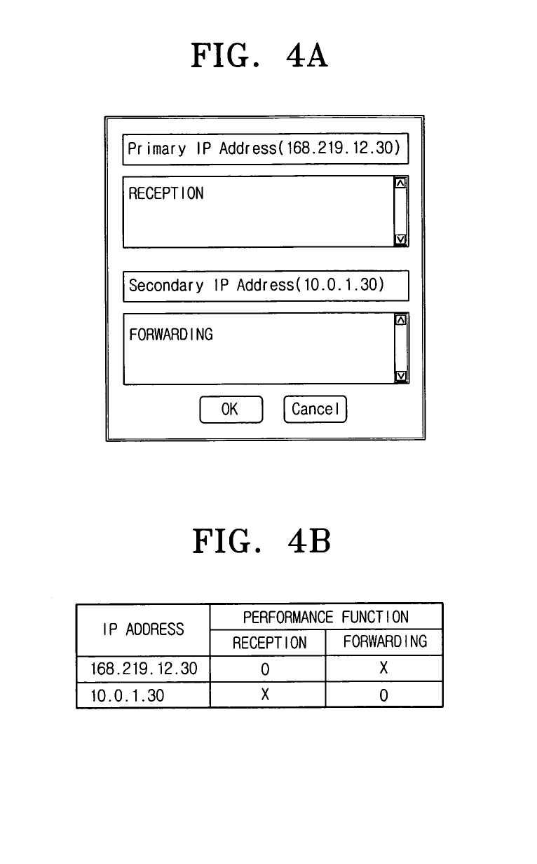

Referring to FIGS. 4A and 4B, before describing the controlling of image data forwarding of the NIC controlling part 317, the ‘IP address-performance function table’ is described as follows. The ‘IP address-performance function table’ indicates a table showing performance functions of the IP addresses of the NIC 310. As described above, ‘168.219.12.30’ and ‘10.0.1.30’ are allocated for the IP addresses of the NIC 310 corresponding to the networks 100 and 200, for example. The ‘performance functions’ are set-up functions that the MFP 300 can perform. The ‘functions’ include a function of image data-reception that the NIC 310 receives image data from the terminal devices 110, 120, 210, 220, and a function of image data-forwarding that the NIC 310 transmits image data to the terminal devices 110, 120, 210, 220.

The performance function for IP address is set up using a user interface of a personal computer, or other suitable processing device, connected to the MFP 300 by a user. An example of the user interface is shown in FIG. 4A. According to the user interface of FIG. 4A, an ‘image data-reception’ function is set up for a primary IP address 168.219.12.30 and an ‘image data-forwarding’ function is set up for a secondary IP address 10.0.1.30. When the performance functions for the IP addresses are set up according to the user interface of FIG. 4A, the corresponding ‘IP address-performance function table’ is shown as FIG. 4B. After the ‘IP address-performance function table’ is generated in a personal computer, or other suitable processing device, and transmitted to the NIC 310, the NIC controlling part 317 stores the ‘IP address-performance function table’ in the NIC memory 319.

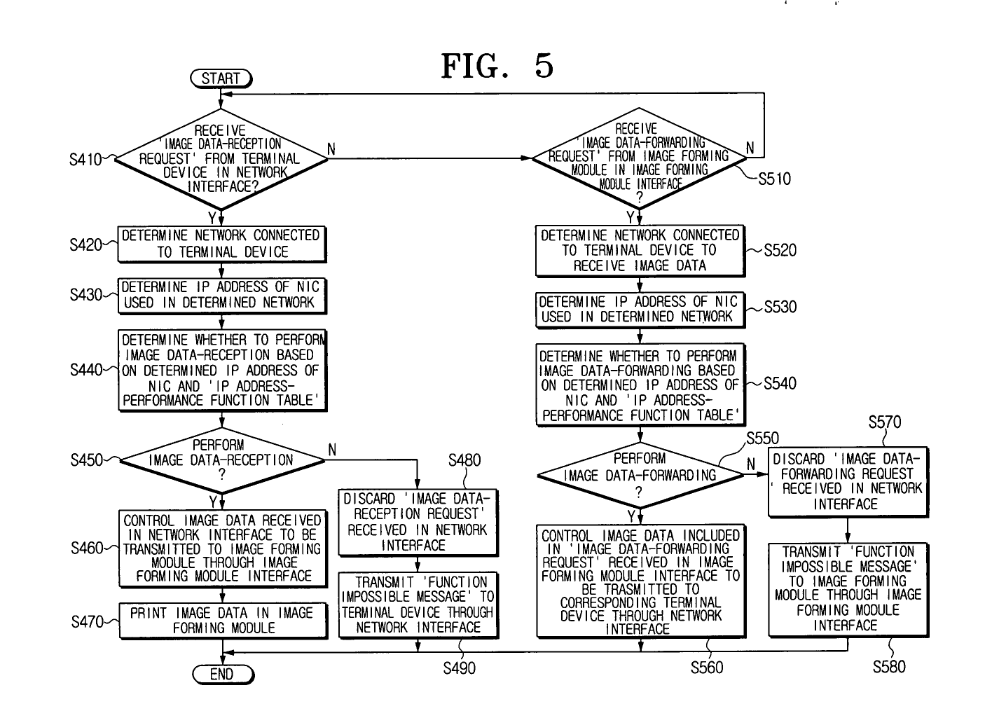

Based on the ‘IP address-performance function table’ stored in the NIC memory 319, a process or operation of the NIC controlling part 317 to control image data forwarding is described with reference to FIG. 5. FIG. 5 is a flow chart describing a method of controlling image data forwarding according to a performance function of each IP address according to an embodiment of the invention.

Referring to FIG. 5, the network interface 313 receives an ‘image data-reception request’ from a terminal device (operation S410), and then the NIC controlling part 317 determines a network connected to the terminal device (operation S420). The network can be determined based on an IP address of the terminal device included in the received ‘image data-reception request’. Where, for example, the terminal device which has transmitted the ‘image data-reception request’ is the terminal device A 110, the terminal device A 110 is connected to the first network 100 so that a network determined in operation S420 becomes the first network 100. Likewise, where the terminal device which has transmitted the ‘image data-reception request’ is the terminal device B 120, a network determined in operation S420 becomes the first network 100. On the other hand, where the terminal device which has transmitted the ‘image data-reception request’ is the terminal device C 210 or the terminal device D 220, a network determined in operation S420 becomes the second network 200.

Next, the NIC controlling part 317 determines an IP address of the NIC 310 used in the network determined in operation S420. Where a network determined in operation S420 is the first network 100, an IP address of NIC 310 used in the first network 100 is ‘168.219.12.30’ so that an IP address of the NIC 310 determined in operation S430 is ‘168.219.12.30’. On the other hand, where a network determined in operation S420 is the second network 200, an IP address of the NIC 310 determined in operation S430 is ‘10.0.1.30’. Subsequently, the NIC controlling part 317 determines whether to perform image data-reception (operation S440) based on the IP address of the NIC 310 determined in operation S430 and the ‘IP address-performance function table’.

Continuing in regard to operation fS440, where it is assumed that the ‘IP address-performance function table’ is the same as FIG. 4B, and where the IP address of the NIC 310 determined in operation S430 is ‘168.219.12.30’, it is determined that image data-reception is possible in operation S440. On the other hand, where the IP address of the NIC 310 determined in S430 is ‘10.0.1.30’, it is determined that image data-reception is not possible in operation S440. Where it is determined that image data-reception is possible in operation S440 (operation S450), the NIC controlling part 317 controls the image data included in the ‘image data-reception request’ received in the network interface 313 to be transmitted to the image forming module 320 through the image forming module interface 315 (operation S460). Accordingly, the image forming module 320 can receive the image data from the terminal device. Next, the image forming module 320 prints the image data (operation S470).

However, where it is determined that image data-reception is not possible in operation S440 (operation S450), the NIC controlling part 317 discards the ‘image data-reception request’ received in the network interface 313 (operation S480). In addition, a ‘function impossible message’, or similar message, indicating that the requested function can not be performed is transmitted to the terminal device through the network interface 313 (operation S490).

Continuing with reference to FIG. 5, on the other hand, where the image forming module interface 315 receives the ‘image data-forwarding request’ from the image forming module 320 (operation S510), the NIC controlling part 317 determines a network connected to a terminal device to receive image data included in the ‘image data-forwarding request’ (operation S520). The determination on the network connected to the terminal device to receive the image data in operation S520 is carried out in a similar manner to the above description of the determination of the network connected to the terminal device of operation S420. Next, the NIC controlling part 317 determines the IP address of the NIC 310 used in the network determined in operation S520 (operation S530). The determination of the IP address of the NIC used in the determined network in operation S530 is carried out in a similar manner to the above description of the determination of the IP address of the NIC used in the determined network of operation S430.

Subsequently, the NIC controlling part 317 determines whether to perform the image data-forwarding based on the IP address of the NIC 310 determined in operation S530 and the ‘IP address-performance function table’ (operation S540). In operation S540, where it is assumed that the ‘IP address-performance function table’ is the same as FIG. 4B, and where the IP address of the NIC 310 determined in operation S530 is ‘168.219.12.30’, it is determined that image data-forwarding is not possible in operation S540. However, on the other hand, where the IP address of the NIC 310 determined in operation S530 is ‘10.0.1.30’, it is determined that image data-forwarding is possible in operation S540.

Where it is determined that image data-forwarding is possible in operation S540 (operation S550), the NIC controlling part 317 controls the image data included in the ‘image data-forwarding request’ received in the image forming module interface 315 to be transmitted to the corresponding terminal device through the network interface 313 (operation S560). Accordingly, the corresponding terminal device can receive the image data from the MFP 300. However, where it is determined that image data-forwarding is not possible in operation S540 (operation S550), the NIC controlling part 317 discards the ‘image data-forwarding request’ received in the network interface 313 (operation S570). In addition, a ‘function impossible message’, or similar message, indication that the requested function can not be performed is transmitted to the image forming module 320 through the image forming module interface 315 (operation S580).

The process of controlling image data forwarding has been described previously referring to the ‘IP address-performance function table’ according to an exemplary embodiment, such as with regard to FIGS. 2 through 4B. In the exemplary embodiment, the ‘image data-reception function’ and ‘image data-forwarding function’ as the functions of the MFP 300 are used as an example to illustrate and describe aspects of the invention and, therefore, the functions of the MFP 300 can vary to include other suitable functions for an image forming apparatus, such as the MFP 300.

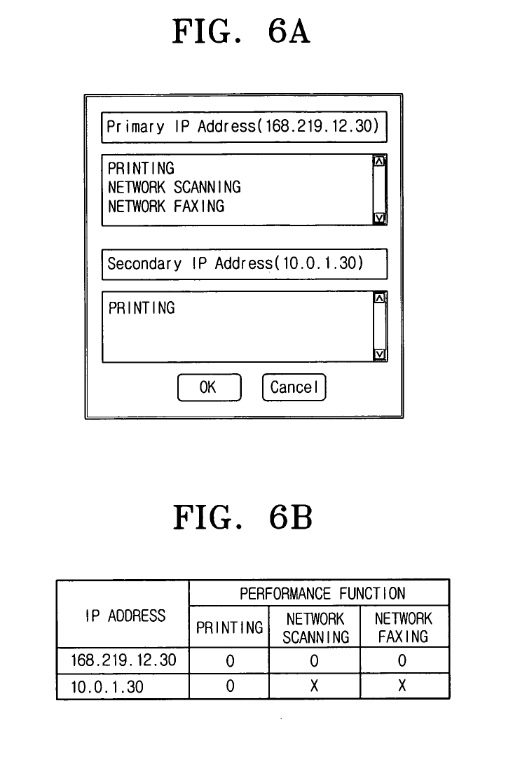

As another example, referring also to FIGS. 6A and 6B, the functions of the MFP 300 can also include and can be divided into a printing function to receive and print data, as print data, from the terminal devices 110, 120, 210, 220, a network scanning function to transmit scan data generated through scanning to the terminal devices 110, 120, 210, 220, and a network facsimile, or faxing, function to transmit facsimile, or fax, data generated by the MFP 300 to the terminal devices 110, 120, 210, 220 and to print fax data transmitted from the terminal devices 110, 120, 210, 220.

Where it is assumed that the functions of the MFP 300 are similar to those described above, according to a user interface of FIG. 6A, the functions of ‘printing’, ‘network scanning’ and ‘network faxing’ are set up for the primary IP address 168.219.12.30, and the function of ‘printing’ is set up for the secondary IP address 10.0.1.30. Additionally, where performance functions for the IP addresses are set up according to the user interface of FIG. 6, the corresponding ‘IP address-performance function table’ is shown in FIG. 6B. Based on the ‘IP address-performance function table’ stored in the NIC memory 319, the operation of the NIC controlling part 317 to control image data forwarding for the functions of ‘printing’, ‘network scanning’ and ‘network faxing’ is carried out similar to that previously described with reference to FIG. 5.

Further, the NIC 310, in the exemplary aspects of the invention of FIGS. 2 through 6B has two IP addresses. However, the number of IP addresses of the NIC 310 is not limited to two IP addresses, and the above described aspects of the invention can be also applied to three or more IP addresses of the NIC 310.

Additionally, according to aspects of the invention, performance functions can be set up differently for each ‘IP address’ of the NIC 310. Also, the ‘IP address’ is one example of various addresses to which the aspects of the invention apply, and even where performance functions can be set up differently for various types and kinds of addresses, other than an ‘IP address’, the aspects of the invention, such as discussed with respect to FIGS. 2 through 6B can be similarly applied.

As can be appreciated from the above description, according to aspects of the invention, whether to forward image data between an external device and the image forming apparatus can be controlled according to the performance functions of the image forming apparatus set up for various addresses, such as IP addresses. Accordingly, a single input operation can control performance functions of the image forming apparatus to the terminal devices connected to a network with a particular address so that an input operation of a user can be simplified. In addition, whether to limit functions can be decided according to a user's selection, and therefore, aspects of the invention can promote convenience to the user.

The foregoing embodiments, aspects and advantages are merely exemplary and are not to be construed as limiting the invention. Also, the description of the embodiments of the invention is intended to be illustrative, and not to limit the scope of the claims, and various other alternatives, modifications, and variations will be apparent to those skilled in the art. Therefore, although a few embodiments of the invention have been shown and described, it would be appreciated by those skilled in the art that changes may be made in the embodiments without departing from the principles and spirit of the invention, the scope of which is defined in the claims and their equivalents.

What is claimed is:

1. A network interface apparatus of an image forming apparatus, to connect to one or more networks for communication with the one or more networks, and allocated a corresponding address for each of the one or more networks respectively, comprising:
a memory to store an address-performance function indicating a corresponding function that the image forming apparatus performs for each address of the network interface apparatus; and
a controlling part to determine an address of the network interface apparatus in a network connected to an external terminal device, to determine whether the image forming apparatus performs the corresponding function based on the determined address and the address-performance function stored in the memory, and to control whether to forward image data between the external terminal device and the image forming apparatus based on the determination.

2. The network interface apparatus of claim 1, wherein:
the controlling part executes control to forward the image data between the external terminal device and the image forming apparatus, in response to the determination to perform the corresponding function, and
the controlling part executes control not to forward the image data between the external terminal device and the image forming apparatus, in response to the determination not to perform the corresponding function.

3. The network interface apparatus of claim 2, wherein:
the controlling part discards the image data and transmits a message that performance of the corresponding function is not possible to one of the external terminal device and the image forming apparatus, in response to the determination not to perform the corresponding function.

4. The network interface apparatus of claim 1, further comprising:
a network interface to communicate with the external terminal device through the network connected to the external terminal device; and
an image forming module interface to communicate with an image forming module of the image forming apparatus,
wherein the controlling part executes control whether to forward the image data between the network interface and the image forming module interface based on the determination of whether the image forming apparatus performs the corresponding function.

5. The network interface apparatus of claim 4, wherein:
the controlling part determines whether to perform image data-reception by the image forming apparatus based on the address of the network interface apparatus in the network connected to the external terminal device and the address-performance function, in response to the network interface receiving a request for image data-reception from the external terminal device, and
in response to the determination of the controlling part to perform image data-reception, the controlling part executes control to forward the image data included in the image data-reception request received in the network interface to the image forming module through the image forming module interface, and
in response to the determination of the controlling part not to perform image data-reception, the controlling part discards the image data-reception request received in the network interface.

6. The network interface apparatus of claim 5, wherein:
the image data-reception includes at least one function of to print data, as print data, received from the external terminal device and to print facsimile data received from the external terminal device.

7. The network interface apparatus of claim 4, wherein:
the controlling part determines whether to perform image data-forwarding by the image forming apparatus based on the address of the network interface apparatus in the network connected to the external terminal device to receive the image data included in the image data-forwarding request and the address-performance function, in response to the image forming module interface receiving an image data-forwarding request from the image forming module, and
in response to the determination of the controlling part to perform image data-forwarding, the controlling part executes control to transmit the image data included in the image data-forwarding request received in the image forming module interface to the external terminal device through the network interface, and
in response to the determination of the controlling part not to perform image data-forwarding, the controlling part discards the image data-forwarding request received in the image forming module interface.

8. The network interface apparatus of claim 7, wherein:
the image data-forwarding includes at least one function of to transmit scan data generated by the image forming module to the external terminal device and to transmit facsimile data generated by the image forming module to the external terminal device.

9. A method of controlling image data forwarding by a network interface apparatus of an image forming apparatus, to connect to one or more networks to communicate with the one or more networks, and allocated a corresponding address for each of the one or more networks respectively, comprising:
determining the corresponding address of the network interface apparatus in a network connected to an external terminal device;
determining whether the image forming apparatus performs a corresponding function based on the determined address and the address-performance function indicating whether performance of the corresponding function is possible by the image forming apparatus for the corresponding address of the network interface apparatus; and
controlling whether to forward image data between the external terminal device and the image forming apparatus based on the determination of the performance of the corresponding function by the image forming apparatus.

10. The method of claim 9, wherein the controlling operation comprises:
executing control to forward the image data between the external terminal device and the image forming apparatus, in response to the determination to perform the corresponding function; and
executing control not to forward the image data between the external terminal device and the image forming apparatus, in response to the determination not to perform the corresponding function.

11. The method of claim 10, wherein the controlling operation further comprises:
discarding the image data, in response to the determination not to perform the corresponding function; and
transmitting a message that performance of the corresponding function is not possible to one of the external terminal device and the image forming apparatus.

12. The method of claim 9, wherein:
the controlling operation controls whether to forward the image data between the network interface apparatus, that communicates with the external terminal device through a network connected to the external terminal device, and an image forming module interface, that communicates with an image forming module of the image forming apparatus, based on the result of the determination of the performance of the corresponding function by the image forming apparatus.

13. The method of claim 12, wherein the controlling operation further comprises:
determining the network connected to the external terminal device, in response to the network interface apparatus receiving a request for image data-reception from the external terminal device;
determining whether to perform image data-reception by the image forming apparatus based on the address of the network interface apparatus used in the determined network and the address-performance function;
executing control to transmit the image data included in the image data-reception request received in the network interface apparatus to the image forming module through the image forming module interface, in response to the determination to perform image data-reception; and
discarding the image data-reception request received in the network interface apparatus, in response to the determination not to perform image data-reception.

14. The method of claim 13, wherein:
the image data-reception includes at least one function of to print data, as print data, received from the external terminal device and to print facsimile data received from the external terminal device.

15. The method of claim 12, wherein the controlling operation further comprises:
determining the network connected to the external terminal device to receive the image data included in an image data-forwarding request, in response to the image forming module interface receiving the image data-forwarding request from the image forming module;
determining whether to perform image data-forwarding by the image forming apparatus based on the address of the network interface apparatus used in the determined network and the address-performance function;
executing control to forward the image data included in the image data-forwarding request received in the image forming module interface to the external terminal device through the network interface apparatus, in response to the determination to perform image data-forwarding; and
discarding the image data-forwarding request received in the image forming module interface, in response to the determination not to perform image data-forwarding.

16. The method of claim 15, wherein:
the image data-forwarding includes at least one function of to transmit scan data generated by the image forming module to the external terminal device and to transmit facsimile data generated by the image forming module to the external terminal device.

17. An image forming apparatus, comprising:
an image forming module to generate and print image data; and
a network interface to determine whether to forward the image data between an external terminal device and the image forming module, the network interface determining whether to perform a corresponding function to forward the image data by an address-performance function indicating each corresponding function to perform for the address of the network interface in a network connected to the external terminal device.

18. A method of controlling image data forwarding by a network interface apparatus of an image forming apparatus, comprising:
determining the corresponding address of the network interface apparatus in a network connected to an external terminal device;
determining whether the image forming apparatus performs a corresponding function based on the determined address and the address-performance function indicating whether performance of the corresponding function is possible by the image forming apparatus; and
controlling whether to forward image data between the external terminal device and the image forming apparatus based on the result of the determination as to whether performance of the corresponding function by the image forming apparatus is possible.

19. The method of claim 18, wherein the controlling operation further comprises:
executing control to forward the image data between the external terminal device and the image forming apparatus, in response to the determination to perform the corresponding function; and
executing control not to forward the image data between the external terminal device and the image forming apparatus, in response to the determination not to perform the corresponding function.

20. The method of claim 19, wherein the controlling operation further comprises:
discarding the image data, in response to the determination not to perform the corresponding function.

21. The method of claim 20, wherein the controlling operation further comprises:
transmitting a message that performance of the corresponding function is not possible to one of the external terminal device and the image forming apparatus.
